(19) United States
(12) Patent Application Publication
(10) Pub. No.: US 2019/0245865 A1
(43) Pub. Date: Aug. 8, 2019

(54) Method for data transmission between an encoder and a motor and/or actuator control unit via an insecure channel

(71) Applicant: Hengstler GmbH, Aldingen (DE)

(72) Inventors: Johann BUECHER, Aldingen (DE); Martin LlNDEN, Donaueschingen (DE); Wolfgang KLAIBER, Hausen (DE)

(21) Appl. No.: 16/269,107

(22) Filed: Feb. 6, 2019

(30) Foreign Application Priority Data
Feb. 8, 2018 (DE) 102018102788.5

(51) Int. Cl. H04L 29/06

(52) U.S. Cl. CPC H04L 63/126; H04L 63/166; H04L 69/165; H04L 63/0876

(57) ABSTRACT

A method for data transmission between an encoder and a motor and/or actuator control unit via an insecure multi-channel channel, the multi-channel channel being formed as a black channel that forms a non-secure transmission channel that is verified by a higher-level or downstream instance, wherein an additional security protocol is superimposed on the black channel, comprising the non-secure protocol thereof, and the secure protocol transmits additional data, relating to the transmission via the black channel, to two mutually independent evaluation units which generate a verifiable redundancy that is evaluated in a downstream functional module.

### FIELD

The invention relates to a method and a device for data transmission between an encoder and a motor control unit and/or an actuator control unit via an insecure multi-channel channel.

### BACKGROUND

EP 2 867 624 B1, by the same applicant, describes a multi-channel rotary encoder that is also suitable for transmitting data between an encoder and a downstream control unit, secure transmission taking place by the absolute and/or incremental position values generated by the position transducer being converted, using an interpolation module and a quadrature encoder interface, into mutually redundant location positions that are supplied to the control unit, in the form of secure data, on two parallel channels.

However, a disadvantage of the known method for operating a multi-channel rotary encoder is the increased complexity when generating mutually redundant location positions that are supplied to a control unit, in the form of secure data, via two channels.

Increased complexity results because the data integrity of the transmitted data has to be verified and ensured over the entire transmission path, and this is associated with relatively high complexity of the components used therefor.

EP 2 148 178 B1 describes a method for digital, bi-directional data transmission between a control unit and a position measuring system, particular frames of a specified bit length being transmitted.

A number of processing units, connected one behind the other in series, is provided, which units transmit parts of the overall data volume in mutually separated cycles and in different frames.

A disadvantage of this arrangement is that a long data transmission time has to be accepted, and the frequency of errors, due to external influences that may act on the signal chain, thus increases.

The plurality of transmission cycles which occur one after the other in series furthermore brings about a delayed reaction time.

This document does not provide the option that data could be transmitted on insecure data channels. Although a verification of the quality of the transmitted data is also provided within the context of the sequential transmission, it is not clear whether the specified quality check is sufficient for meeting the increased requirements in the event of data transmission via insecure channels.

In US 2010/02001373 A1, the pulse width of one period is compared with the pulse width of the following period in order to thus obtain a statement regarding the integrity of the data.

These error correction mechanisms can be seen in FIGS. 3, 5, 6 and 7, and the associated error or evaluation matrix is described in FIG. 8.

US 2010/02001373 A1 does not use position data from a position transducer, but instead merely transmits A/B incremental signals of a pulse encoder. However, no position-transformed data are transmitted. In the mentioned document, the term “A/B incremental signals” is understood as a position change, but not a specification regarding the actual position of an object. It is thus not possible for position data to be transmitted, because there is no position transducer.

The mentioned document does not disclose a black channel either, since FIG. 9 is merely a block diagram of an encoder and a “control device” and a cable 20. There is no arrangement of a “black channel,” as is provided in the present invention.

The difference between a “black channel” according to the invention and the simple cabling in US 2010/02001373 A1 is that, in the invention, an additional security layer is superimposed on a black (=insecure) channel, meaning that the security layer provides additional data regarding the integrity and security of the data transmitted via the black channel, i.e. generates redundancy, whereas this is specifically not the case in US 2010/02001373 A1.

The feature of a black channel and the feature of a position transformation are thus missing from the document mentioned.

US 2008/0176530 A1 relates to a two-channel method for monitoring an output signal that changes under the influence of input signals.

A signal source 10 is provided, which transmits signals A, B in a mutually separated manner, via two different channels D1 and D2.

This is merely redundant, two-channel transmission of identical signals, no black channel, containing an additional security layer, being provided.

FIG. 2 of the mentioned document does not extend beyond this difference, since, in FIG. 2, it is simply the case that the inverted signals AB are transmitted via one channel and the signals BA are transmitted via the other channel, and the signals are compared with one another at the output.

This is therefore the transmission of analog signals from a single signal source, as described therein. The document does not define data transmission of independent position data via secure protocols, which data are transmitted via a transmission medium and using what is known as a black channel that carries out specific additional error monitoring.

Accordingly, position data are not transmitted in US 2008/0176530 A1, but instead analog data which are then converted into digital data using internal AD converters and are compared with one another by two microprocessors operated in parallel. This is therefore a case of position changes but not position data.

Therefore, proceeding from US 2010/02001373 A1, the object of the invention is that of developing a method for data transmission between an encoder and a downstream processing unit in such a way as to allow for a high transmission quality in a quick transmission time and in a manner requiring substantially less complexity with regard to circuit components.

### SUMMARY

In order to achieve the stated object, a method for data transmission between an encoder and a motor and/or actuator control unit via an insecure multi-channel channel provides that the multi-channel channel is formed as a black channel that forms a non-secure transmission channel that is verified by a higher-level or downstream instance an additional security protocol is superimposed on the black channel, comprising the non-secure protocol thereof, and the security protocol transmits additional data, preferably relating to the integrity and security of the data transmitted via the black channel, to two mutually independent evaluation units which generate a verifiable redundancy that is evaluated in a downstream functional module.

When transmitting position data in the manner striven for in the present invention, substantially higher requirements are made for the data quality because the absolute position of the rotary encoder has to be checked at each point in time, which is precisely not the case in the mentioned documents.

According to the technical teaching of the claims, data transmission is carried out of position data that originate from a position transducer. However, in US 2010/0201373 A1, only A/B incremental signals are transmitted by the pulse encoder shown therein, from which signals it is not possible to derive absolute position signals without making further calculations.

Furthermore, there is no position transformation in US 2010/0201373 A1. This is different from the invention.

The term of an “insecure channel” used in the present invention is defined on page 5, line 10 ff.:

According thereto, this is preferably a non-secure protocol that is expanded by security features, and the security features are verified in a separate security application:

FIG. 9 of US 2010/0201373 A1 merely shows A, B analog signals which are not verified in any way. This is where the invention comes in, preferably defining a protocol comprising position data and comprising additional security features (life counter, CRC, etc.).

The multi-channel nature of the insecure channel according to the invention is substantiated inter alia by mutually independent positions Pos#1 and Pos#2 from the position transducer 5.

According thereto, the multi-channel nature according to the invention does not relate to the number of wires in the cable, but instead to the number of mutually independently determined positions.

In contrast thereto, the incremental signals A/B of US 2010/0201373 A1 cannot be considered to be mutually redundant or mutually independent, but instead those signals are necessarily single-channel since the signal origin can be traced back to a non-redundant source. Precisely the monitoring functions described in US 2010/0201373 A1 in the “anormaly monitoring device” are dependent on the mutual dependency of the signals. This is in contrast with the invention.

Due to the system, “common-cause errors” that originate from interference of a general kind cannot be detected in US 2010/0201373 A1.

The same criticism mentioned for US 2010/0201373 A1 also applies for US 2008/0176530 A1. Analog signals from one signal source are supplied to a plurality of transmission media. In the present invention, in contrast, secure protocols comprising independent position data are transmitted via one transmission medium.

The multi-channel channel is preferably formed as a black channel that forms a non-secure transmission channel that is verified by a higher-level or downstream instance, an additional security protocol being superimposed on the black channel, comprising the non-secure protocol thereof, and the security protocol transmitting additional data, preferably relating to the integrity and security of the data transmitted via the black channel, to two mutually independent evaluation units which generate a verifiable redundancy that is evaluated in a downstream functional module.

It is furthermore preferable for the black channel to extend continuously from the position transformation to the secure evaluation, and for it to be possible for interference of a general type to also be detected inside the encoder and inside the motor controller-side logic unit.

A further feature of the invention is that the data transmission between an encoder and a downstream processing unit takes place through an insecure channel, and that, in the case of the data transmission that takes place via an insecure channel, a secure evaluation unit is arranged downstream or at the output of the insecure channel, which unit verifies the data from the insecure channel and actuates a downstream motor unit only when the security of the verified data has been confirmed.

An advantage of the invention is that the data of the encoder can be transmitted in a single-channel or multi-channel manner over a transmission path that is insecure, i.e. external influences (interference) may act there, without it being necessary to already verify the transmitted data for integrity and data security in the region of said data transmission.

Examples for transmission errors on the insecure channel at the level of the protocol packets in a non-secure channel are:

1. repetition
2. loss
3. insertion
4. incorrect sequence
5. distortion
6. delay
7. mixing of secure and non-secure messages.

An insecure channel is understood as a “black channel” principle for communication in security-related systems.

The black channel is accordingly a non-secure transmission channel that is verified by a higher-level or downstream instance.

This is for example a non-secure protocol that is expanded by security features, and the features (security application) are verified in an application.

Accordingly, the advantage of using an insecure channel is the freedom in the transmission of data between an encoder and a downstream motor control unit without the need to use complex functional modules that verify the integrity and the security of the data during the entire transmission.

According to the invention, this occurs only at the end of the transmission path, specifically only when what is known as a secure evaluation unit is arranged at the output of the insecure channel, which unit is at least two-channel, and in addition a cross-comparison of the channels is also carried out in the region of the two-channel evaluation unit. However, the two-channel design does not relate to the number of wires in the cable, but instead to the number of mutually independently determined positions.

With regard to the following description, it is furthermore the case that the design of the evaluation unit having two channels is preferred. However, the invention is not limited to a two-channel design. Therefore, more than two channels can also be used. In particular, due to the advantageous cross-comparison of the channels, an even number of channels can be used. Even if the present description describes a two-channel design, this is not to be understood as limiting within the meaning of the above definition.

An “approval” occurs at the output of the secure evaluation unit and the downstream motor unit is actuated only in the event of all the signals of the two evaluation units and the cross-comparison unit connected therebetween corresponding.

According to a preferred embodiment of the invention, the secure evaluation unit at the end or at the output of the insecure channel consists of a series of control requests that have to be fulfilled with specific results of a verification unit. An “approval” results as the output signal at the output of the secure evaluation unit, and thus the data, now recognized as secure, are connected through to the encoder, only when all the control requests present have been cumulatively fulfilled.

Accordingly, an advantage of said method according to the invention is that insecure data transmission can take place at very high speed over a very long transmission path, and that said data are verified only at the output of said path.

In contrast to a conventional standard protocol in which only position data are transmitted, the invention provides for further data to be transmitted, in order to identify transmission errors.

Said data are, for example:

1. Life counter (LC) or
2. CRC data (cyclic redundancy check data)
3. Furthermore, error bits and warning bits can be transmitted, which bits are all contained in the data transmission message.
4. Likewise, delays of the data are checked by the transmission of the data being demanded in specified time windows. If the time window is exceeded, an error is identified and the transmission is interrupted.
5. This also applies to the loss of data, which likewise leads to an error message and, when assessed accordingly, to an interruption of the transmission.

According to a first embodiment of the invention, an encoder, which is designed as an optical encoder for example, is driven by a mechanical interface (gears, motor shaft) of a motor system. The invention is not limited thereto. Any desired encoder can be used, for example also a magnetic or inductive or capacitive encoder.

In this case, the position values obtained by the decoder are converted, preferably by two mutually separated channels which are both connected to an electrical interface that is part of the encoder system.

It is important in this case for an insecure channel, which may be formed as a two- or four-wire line and which is connected to the motor-side motor control unit, to now be connected at the output of the encoder-side interface.

In this case, it is irrelevant how long the insecure channel is and how long the two- or four-wire line is, because it does not matter whether or not errors are introduced via said two- or four-wire line, since the errors are later identified in the evaluation unit.

An advantage is that the error analysis takes place in the motor control unit, and in particular in a specific evaluation module arranged therein.

Arranging the secure evaluation unit on the motor side is particularly advantageous because the data transmission between the encoder side and the motor control unit can now take place, according to the invention, via the insecure channel over any desired lengths and media.

A transmission length of this kind may be 100 meters or more.

According to a further embodiment of the invention, an insecure channel through the downstream master interface is provided directly at the output of the encoder, and a secure evaluation unit, at the output of which the motor unit is then arranged, is arranged only at the output (=end) of the insecure channel.

According to a second embodiment, the insecure channel also extends through the electrical master interface, and the secure evaluation unit is also integrated in said master interface.

According to a third embodiment, the insecure channel also extends through the motor control unit, and the secure evaluation unit according to the invention is arranged only at the output of the motor control unit, while, in a further embodiment, the master interface is integrated, together with the motor control unit, in one single functional module, and the secure evaluation unit according to the invention is then arranged at the output of said functional module.

In order to meet the requirements of the secure evaluation unit, embodiments provide different control requests that must all be fulfilled cumulatively; otherwise the secure evaluation unit does not release the downstream motor.

The subject matter of the present invention results not only from the subject matter of the individual claims, but also from the combination of the individual claims with one another.

All the specifications and features disclosed in the documents, including the abstract, and in particular the spatial embodiment shown in the drawings, are claimed as being essential to the invention, insofar as they are novel, either individually or in combination, over the prior art.

### BRIEF DESCRIPTION OF THE DRAWINGS

The invention will be described in greater detail in the following with reference to drawings that show just one embodiment. In this case, further features essential to the invention and further advantages of the invention can be found in the drawings and the description thereof.

In the drawings:

FIG. 1 is a block diagram of a data connection between an encoder and a control unit.

FIG. 2 is a block diagram of a data connection between an encoder and a motor control unit, showing the architecture within the control unit.

FIG. 3 shows a further embodiment, compared with FIG. 2, particular functional modules being combined with one another.

FIG. 4 shows a further embodiment that is modified compared with FIG. 2 and FIG. 3.

FIG. 5 shows the list of the control requests to be cumulatively fulfilled in the secure evaluation unit according to a first embodiment.

FIG. 6 shows a second embodiment that is modified compared with FIG. 5.

FIG. 7 shows the transmission cycle, specifying the transmitted data within a cycle.

FIG. 8 shows the data contents of the response messages shown in FIG. 7, for channel number 1 and channel number 2, and specifically divided into payload and security protocol data.

FIG. 9 is a block diagram showing the data transmission from a functionally secure rotary encoder to a secure evaluation unit.

### DETAILED DESCRIPTION

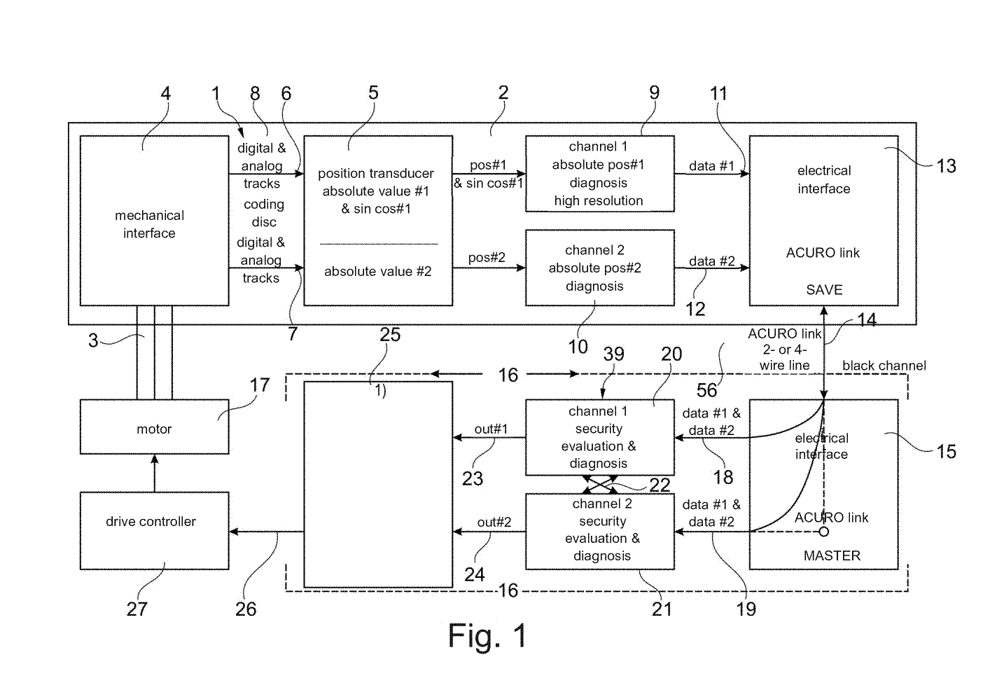

The system architecture 1 of a data connection between an encoder and a motor control unit 41 is shown in a general manner in FIG. 1.

For the sake of simplicity, the functional module that is later described as the motor control unit 41 is also sometimes simply denoted a control unit 16 because it can actuate not only a motor 17 but also other actuation elements.

Instead of a motor, actuation elements of this kind may be any desired actuators, for example hydraulic rams, cylinder drives and the like.

What is important is that the block diagram of a functionally secure rotary encoder 2 is shown in the upper region of FIG. 1, which rotary encoder substantially consists of the mechanical interface 4 which may itself be a gear or a drive shaft that is connected for conjoint rotation to an optical coding disc 8, provided by way of example.

The optical coding disc generates digital and analog signals via appropriate digital and analog tracks and, according to the embodiment shown, the transmission takes place on two different tracks 6 and 7 on a downstream position transducer 5.

Absolute values and incremental values are generated on the channel 1 in the position transducer 5.

Separately therefrom, further absolute values are generated on a channel 2, which values are redundant with the absolute value of channel 1.

The transmission therefore takes place on two different channels no. 1 and no. 2 at the output of the position transducer 5, by way of example the incremental values still being transmitted therewith, as sine-cosine values, via the top channel no. 1, whereas only the absolute values are transmitted on the bottom channel.

This two-channel transmission does not limit the invention (see the definition stated above).

Absolute values can also be transmitted via more than two channels, and likewise incremental values can be transmitted via more than one channel.

What is important is that in any case at least one instance of two-channel transmission takes place on a downstream signal channel 9 by the absolute position values being generated together with diagnostic values and additional information in order to achieve high resolution of the absolute values.

This applies both to the top channel of the signal channel 9 and to the bottom channel, for example by the absolute values also being provided with further diagnostic parameters. This takes place in the region of the signal channel 10.

At the output, the two signal channels 9, 10 form the data channels 11 and 12 which are connected together and in parallel with one another to an electrical interface 13 that is arranged on the functional rotary encoder side and has a particular protocol which, in a manner specific to the patent proprietor, is referred to as the “ACURO link.”

This interface, which is connected as a slave interface 13, then carries out the transmission according to the invention via an insecure channel 14 that is also referred to as the “black channel.” The transmission may take place via a two- or four-wire line, and the data transmission path 56 is one that may be of lengths of up to 100 meters or more. What is important is that no distinction is made between secure and insecure data in the region of the rotary encoder (encoder) 2. The components arranged in the rotary encoder can therefore be constructed in a particularly cost-effective and simple manner.

It is furthermore advantageous for the transmission of said data at the output of the slave interface on the encoder side to now be possible over any desired length, and for signal influences to be able to take place on said insecure channel 14 which influences are, however, identified and excluded in a subsequent process.

According to the invention, a master interface 15 is then arranged on the control unit 16 side, which interface forms the input for the insecure channel 14, according to the invention, according to the embodiment according to FIG. 1, the insecure channel also being guided through the master interface 15. The advantage of this is that secure transmission is likewise not required in the master interface 15 on the motor monitoring side.

The output of the master interface 15 has two data channels 18, 19, the top data channel 18 transmitting the position data of the first channel and of the second channel together, while this likewise occurs, redundantly, in the same manner on the bottom data channel.

Additional security protocol data are also added to both items of data on the data channels 18, 19, as will be explained below.

The security protocol data are added to the signal channels 9 and 10, as has already been specified.

What is important here is that the transmission of the data via the insecure data channel 14 is now verified by a downstream secure evaluation unit 39.

The secure evaluation unit consists of an at least two-channel evaluation unit 20, 21, the evaluation units 20, 21 being designed in substantially the same way and carrying out identical data evaluation.

Since identical data are also entered at the input, according to the invention, in accordance with a further feature of the present invention a congruence comparison is carried out between the identically operating evaluation units 20 and 21 by a cross-comparison module 22 connected therebetween, such that the cross-comparison and the separate evaluation of the joint data no. 1 and no. 2 in the functionally entirely separate evaluation units 20, 21 is always ensured, such that the data are evaluated independently of one another and are compared for synchrony, convergence and identity only in the cross-comparison module connected therebetween.

Therefore, two output channels 23, 24 are also connected at the output of the secure evaluation unit 39 according to the invention, which channels operate independently of one another and likewise in an at least two-channel manner supply the data, identified as secure, to a functional module 25 in an at least two-channel manner via the output channels 23, 24, the functional module being directly connected to the motor controller.

Motor actuation signals are formed in said functional module 25, said signals being for example signals for

1. secure deactivation,
2. secure torque limitation,
3. secure speed limitation,
4. secure limitation of the location, and
5. secure limitation of the current position.
6. An emergency stop function is also integrated.

As a result, the motor control unit 16, 41 is actuated only when the data transmitted via the insecure channel 14 are identified as secure at the output of the secure evaluation unit 39 and have been transmitted identically into the functional module 25 in an at least two-channel manner.

At the output of the functional module 25, a disconnection channel 26 then directly actuates for example the drive controller 27 or other actuator-side or motor-side drive elements, which elements are not shown here for the sake of simplicity.

For the sake of completeness, it is also noted that the motor 17 is connected to the mechanical interface 4 by a mechanical interface 3, for example a drive shaft. This means, for example, a code disc, which codes the angular position of the shaft.

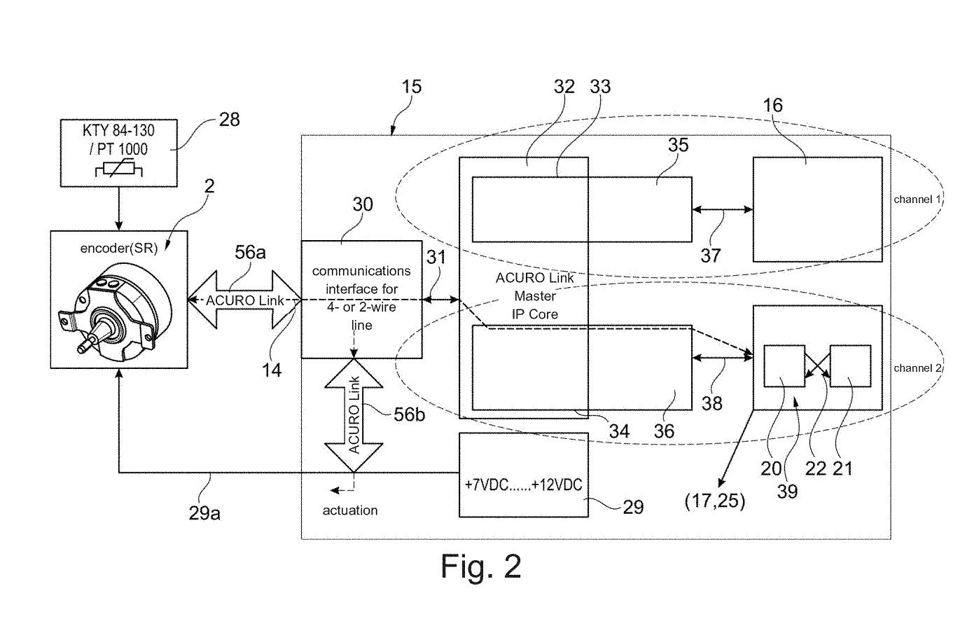

FIG. 2 shows, as a first embodiment, the master/slave structure of a security concept according to the invention, in which it is specified that the secure rotary encoder (encoder) 2 can also be actuated by a temperature sensor 28 for example, and the data transmission at the output of the encoder 2 takes place via a data transmission path 56a that is already formed as an insecure channel 14.

The data transmission path 56a forms the input for a line driver 30 which may form either a two- or a four-wire line. In the embodiment according to FIGS. 2, 3 and 4, two different designs are shown that function independently of one another.

FIGS. 2 to 4 also show that data are returned directly to the encoder 2, via the insecure channel 14, at the output of the line driver 30, over the data transmission path 56b. However, this embodiment can also be omitted or can be provided in isolation.

Two different possibilities for data transmission are thus shown, specifically the data transmission path 56a and the data transmission path 56b, it being possible for the data transmission path 56a to form a four-wire transmission and the data transmission path 56b to form a two-wire transmission.

Therefore, in order to simplify the description, the data transmission path 56b will no longer be shown in the following, because the path may optionally be provided in all the embodiments of FIGS. 2 to 4.

A bi-directional transmission channel 31 is provided at the output of the line driver 30, which channel forms the input for a downstream logic module 32.

What is important is that the insecure channel 14 should be connected through the data transmission path 56a, through the line driver 30 and through the logic module 32, such that no precautions for ensuring the integrity of the data need to be taken over the entire data transmission path. The transmission thus takes place particularly quickly and dynamically.

For this reason, the components 30, 32 can be formed in a particularly simple and cost-effective manner.

The logic module 32 substantially consists of a memory region 33 in which the memory points for the motor location actuation are saved while these are directly connected to an interface 35 that is connected to the control unit 16 by the transmission channel 37.

A memory region 34, which can be accessed from both sides, specifically also from the side of the safety control interface 36 that is in turn connected by a bi-directional transmission channel 38 to the secure evaluation unit 39 according to the invention, also forms part of the logic module 32.

Accordingly, the insecure channel extends, according to the invention, from the output of the encoder as far as the input of the secure evaluation unit 39, which was not known hitherto.

In the manner described above, the secure evaluation unit 39 consists of two evaluation units 20, 21 that are functionally separated from one another and between which the above-mentioned convergence comparison module 22 is arranged.

Irrespective thereof, a power supply 29 is provided, by the lines 29a of which the encoder 2 is actuated.

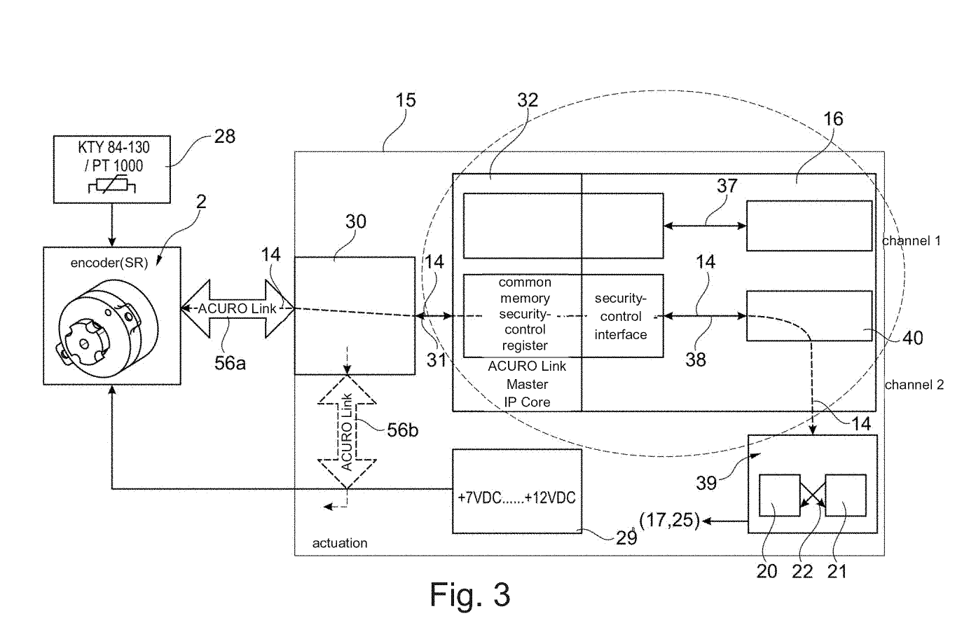

The embodiment according to FIG. 3 differs from the embodiment according to FIG. 2 in that another integration step is provided in the region of the master interface that is arranged on the motor side.

It can be seen here that a further functional module 40 is additionally arranged in the region of the motor-side control unit 16, which functional module acts as a connecting link between the secure data generated in the logic module 32, which data the functional module 40 supplies to the secure evaluation unit 39 via the insecure channel.

This is therefore an interface module that demands the data from the logic module 32 and transmits the data to the secure evaluation unit 39 on request.

It is also important here for the insecure channel 14 to extend as far as the input of the secure evaluation unit 39 which corresponds, in functional terms, to the embodiment of FIG. 2.

If it is intended, according to the embodiment of FIG. 3, to create a secure drive from an insecure drive, then it is sufficient to provide a functional module 40 that demands secure data from the logic module 32 and delivers the data to the input of a secure evaluation unit 39.

This is the particular advantage of the invention, i.e. the fact that conventional, insecure data transmission, as shown in FIGS. 2, 3 and 4 on the basis of the insecure data channel 14, can also be converted into secure data channels if a secure, multi-channel evaluation unit according to the invention is connected at the output or at the end of the insecure channel.

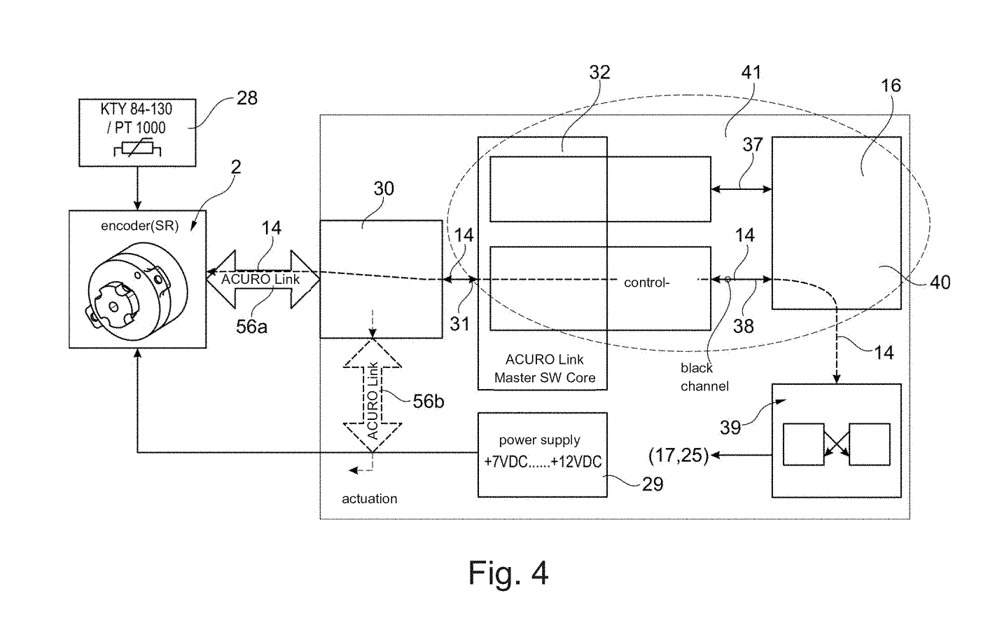

This can also be seen from the embodiment according to FIG. 4, which shows a high degree of integration of the motor interface module. It can be seen that the logic module 32 is now integrated, together with the motor-side control unit 16 and the above-mentioned functional module 40, in the motor control unit 41.

Otherwise, the same reference signs apply for the same parts.

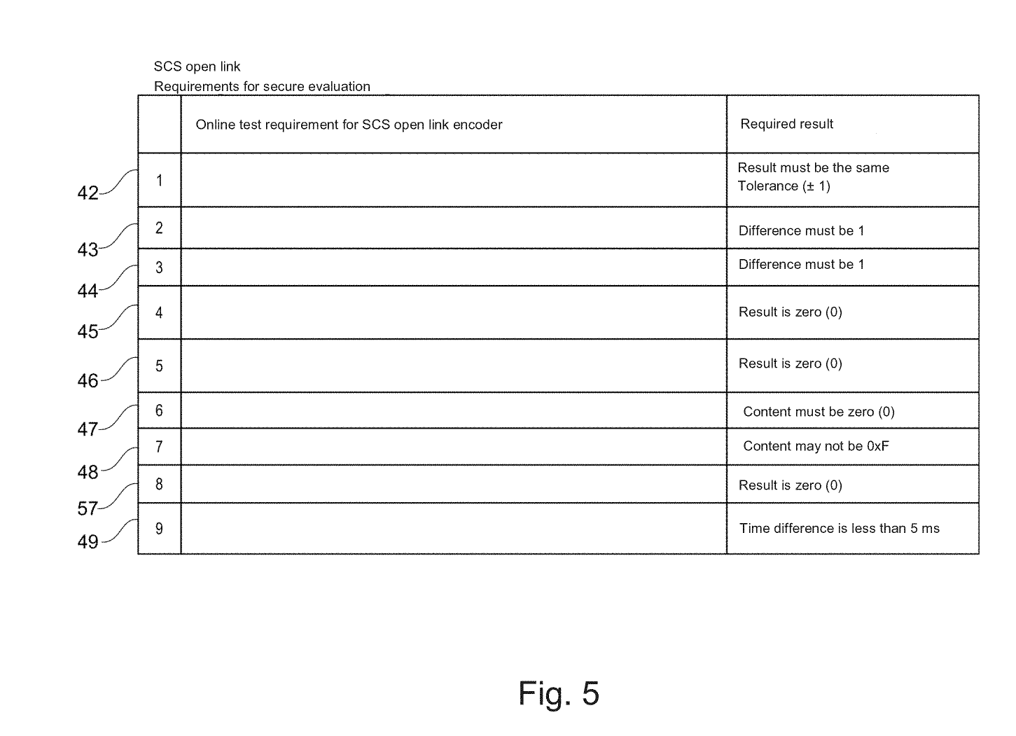

FIG. 5 shows the security request, in a first embodiment, which request takes place within the secure evaluation unit, on two mutually separated evaluation units 20, 21.

Instead of the two-channel evaluation shown, using two evaluation units 20, 21 that are functionally separated from one another, three or more evaluation units may also be provided.

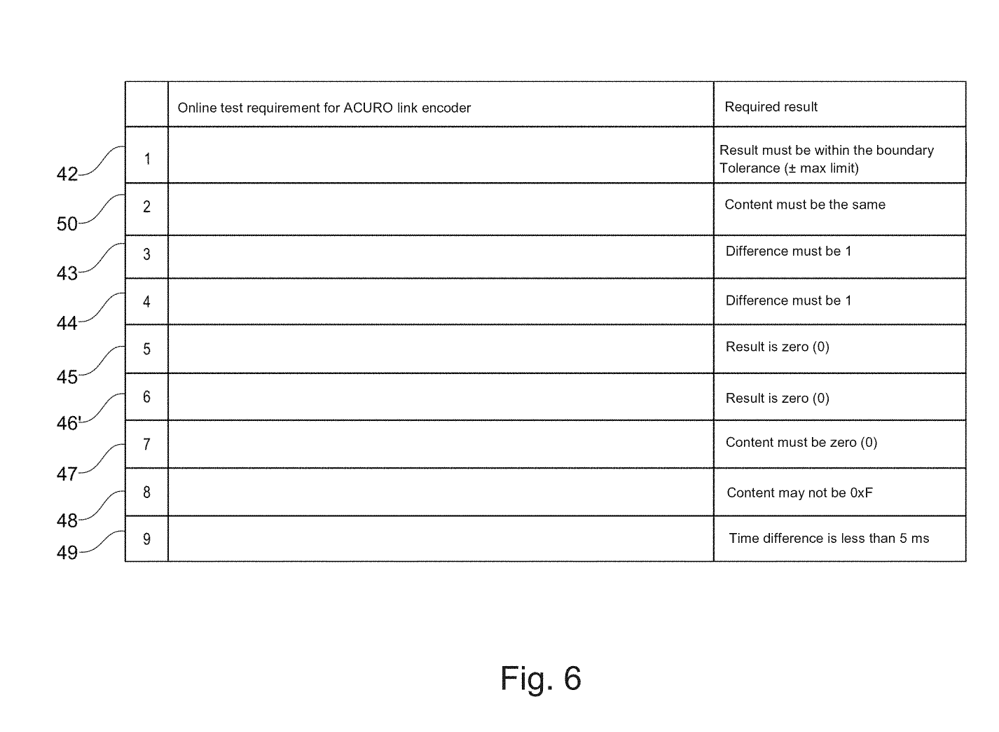

FIGS. 5 and 6 show a number of control requests 42-50, 57, FIG. 5 showing, as an example, that each evaluation unit 20, 21 carries out the following control requests:

1. In the control request 41, the location position of the channel 1 is compared with the location position of the channel 2, which positions are displaced relative to one another by a security offset, and said request requires, as an outcome, for the result to be the same.
2. In the control request 43, the life counter LC1 is called up together with the life counter LC1* of the previous cycle and compared therewith, and the difference must correspond to the integer plus 1.
3. In the control request 44, the life counter LC2 is compared with the life counter LC2* of the previous cycle, and the difference must differ by 1.
4. In the control request 45, the CRC value 1 is detected as a 16-bit value and the result must be 0.
5. In the control request 46, the CRC value 2 is detected as a 16-bit value and the result must likewise be 0.
6. In the control request 47, the alarm bit A1 is compared with the alarm bit A2 and the result must be 0.
7. In the control request 48, the system status is verified and the contents of the system status counter may not correspond to a specified number.
8. In the control request 57, a cyclic redundancy check (CRC) is carried out, over an 8-bit value, and the result must be 0.
9. In the control request 49, the difference between two successive cycles is calculated, which difference may not exceed a value of 5 milliseconds. The result is acceptable if the time difference is less than 5 milliseconds for example.

The control requests mentioned above are merely an example for the criteria according to the invention in the two evaluation units 20, 21, which units each carry out the control requests separately, it being possible, however, for a number of further control requests to be present, for example the presence of data at all, and the like. The list set out above is therefore not to be understood as conclusive.

In contrast to the control request according to FIG. 5, the only difference in the control request according to FIG. 6 is that a location comparison between the position in channel 1 and a copy of this location information in channel 1 is compared, in bits, at the second position, and the result must be identical.

Furthermore, in control request 46′ the cyclic redundancy check CRC2 is calculated in 32-bit form (and not in 16-bit form), and the result must be 0.

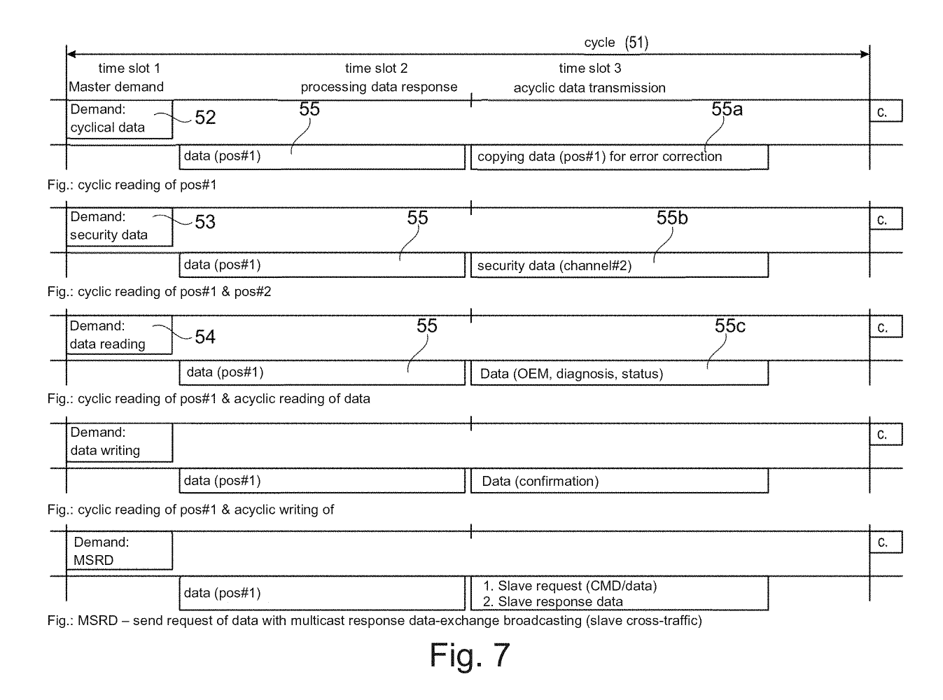

FIG. 7 shows data transmission in a single cycle 51, and this is the significance of the present invention, since all relevant data are transmitted in a single cycle of in the range between 30 microseconds and one millisecond (for example), and this was not possible by serial data transmission according to the prior art.

As a result, the quick data transmission in the region of one cycle 51 is particularly advantageous because the data are verified particularly quickly.

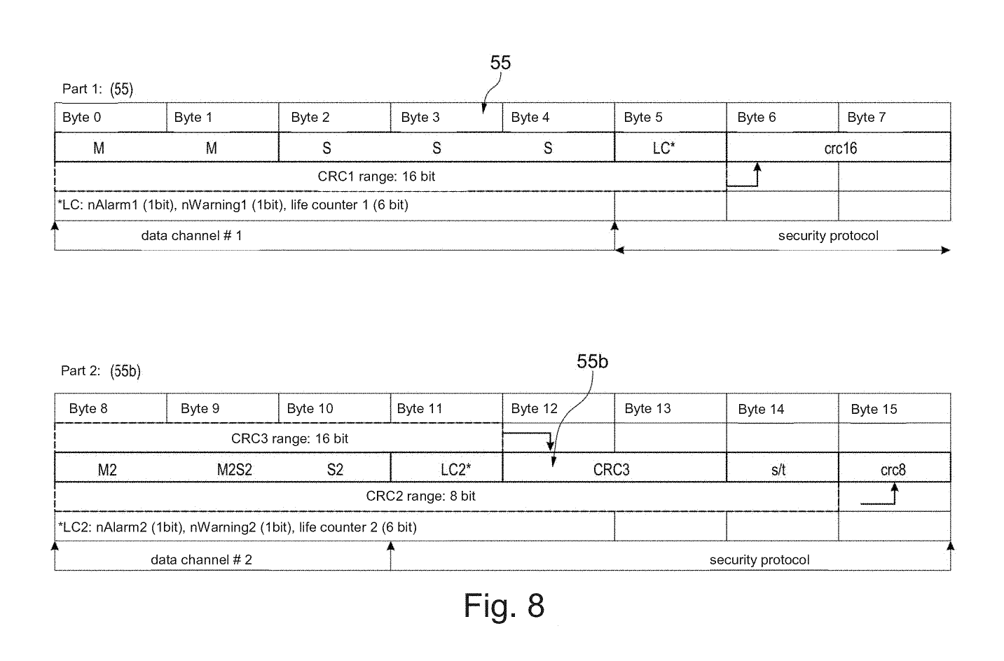

Proceeding from a start command 52, a response message 55 is transmitted at position number 1, meaning that the response message 55 contains all the data that are specified in FIG. 8 as data of data channel number 1.

In the second half of the cycle, a copy of the response message 55 is then transmitted in the form of a data message 55a.

What is important in this case is that the data according to FIG. 8 should then likewise be transmitted in the response message 55 in the event of a different type of start command 53, but that, in the second half of the cycle, a part 2, containing the security data of the channel 2, should then be transmitted, as 55b, in a second response message.

The data 55b are the data that come from the second channel and must correspond to the data of the first channel.

Merely for the sake of completeness, FIG. 7 furthermore shows that other data can also be transmitted, using further start commands 54, specifically following the relevant response message 55, for example data 55c that may for example relate to OEM data, diagnosis data or status data.

Likewise, temperature data and the like can be transmitted, as is specified at the bottom of FIG. 7.

The top of FIG. 8 shows a data transmission message, it being specified that the response message consists of multiturn data M and of further singleturn data S.

The data of a life counter, an alarm bit, a warning bit and the CRC also follow the multiturn/singleturn data, the data as a whole being referred to as a security protocol.

It is furthermore noted that the fields denoted LC* and LC2* in FIG. 8 may be composed of an item of alarm data, an item of error data and a life counter.

The drawing at the bottom of FIG. 8 shows a data message in the second part of the transmission, for example in the part 55b.

It is specified here that the data in channel 2 are now transmitted as multiturn M and singleturn S, the data of channel 2 always being denoted by “2.”

It is clear from this drawing that the data of channel 2 are transmitted within the boundaries marked, and are followed by the data of the security protocol.

The CRC3 is formed by the bits specified on the left-hand side by CRC3 range, while the life counter RC8 is formed by the entire bit path which is specified, therebelow, by CRC2 range.

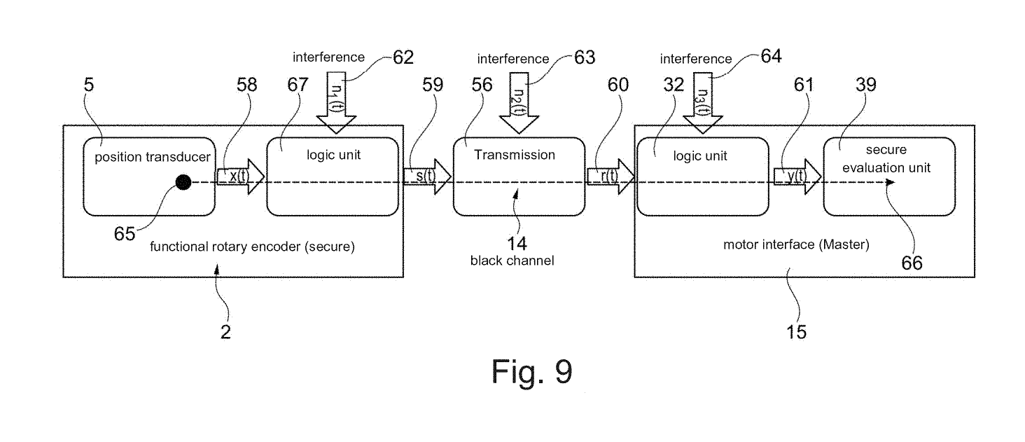

FIG. 9 schematically shows a functional block diagram of secure data transmission, which diagram substantially corresponds to the functional block diagram according to FIG. 1. This is accordingly a generalization of the functional block diagram according to FIG. 1 It can be seen in FIG. 9 that a position transducer 5 is arranged in the secure functional rotary encoder 2, which position transducer can operate for example optically, magnetically inductively, or capacitively, and in which the start 65 of the secure channel 14 is located.

The signals of the position transducer 5 are transmitted, in a single- or two-channel manner and using a specified first transmission function 58, to an associated logic unit 67 that is arranged in the rotary encoder 2, it being specified in the functional block diagram according to FIG. 9 that first interference 62 can already enter the logic unit of the rotary encoder 2, which interference changes the following second transmission function 59 at the output of the logic unit of the rotary encoder 2.

Second interference 63, which can be completely different from the interference 62, may enter the transmission path 56 during the single- or multi-channel transmission, with the result that the third transmission function 60 emerging at the output of the transmission route is also changed by the interference 63.

This all takes place in the region of the black channel 14, and the third transmission function 60 resulting at the output of the transmission path 56 forms the input for the logic unit 32 arranged in the motor interface (master) 15. Fourth interference 64 may also act on the logic unit 32, which interference thus results in a changed fourth transmission function 61 at the output of the logic unit.

The signal which has thus been changed multiple times from the start 65 to the end 66 of the black channel 14 has accordingly undergone varied modifications, and the influences of the interference 62-64 are verified only in the secure evaluation unit 39, and the digital signals are then forwarded only if perfect transmission according to the control requests according to FIGS. 5 to 8 has been identified at the end 66 of the black channel 14.

This results in the advantage of the invention, i.e. the fact that varied interference 62-64 may act on the different transmission modules from as early as the inside of the position transducer, at the start 65 of a black channel, and the black channel 14 extends as far as the inside of the secure evaluation unit 39 (to the end 66), and only then is secure transmission according to the criteria of FIGS. 5 to 8 verified.

Accordingly, it is important in the invention for insecure data transmission over long line paths to be compensated for using cost-effective and simple functional modules, and for verification of the insecure data transmission, for specific security features, to be carried out only at the end 65 of the insecure data transmission in order for it to then be possible to confirm, if the security features are fulfilled, that the data transmission was error-free.

### LIST OF REFERENCE SIGNS

1 system architecture
2 functional rotary encoder (secure)
3 mechanical interface
4 mechanical interface
5 position transducer
6 tracks
7 tracks
8 optical coding disc
9 signal channel
10 signal channel
11 data channel
12 data channel
13 electrical interface (slave)
14 black channel (transmission path)
15 motor interface (master)
16 control unit
17 motor
18 data channel
19 data channel
20 evaluation unit (two-channel)
21 evaluation unit (two-channel)
22 cross-comparison module
23 output channel (evaluation)
24 output channel (evaluation)
25 functional module (evaluation)
26 disconnection channel
27 drive controller
28 temperature sensor
29 power supply
29a line
30 line driver
31 transmission channel
32 logic module
33 memory region
34 memory region
35 interface
36 interface (secure evaluation)
37 transmission channel
38 transmission channel
39 secure evaluation unit
40 functional module
41 motor control unit
42 control request
43 control request
44 control request
45 control request
46 control request
47 control request
48 control request
49 control request
50 control request
51 cycle
52 start command
53 start command
54 start command
55 response message (part 1)
55a part 2 (response)
55b part 2 (response)
55c part 2 (response)
56a data transmission path
56b data transmission path
57 control request
58 transmission function
59 ‘ ‘
’ ’
60 ‘ ‘
’ ’
61 ‘ ‘
’ ’
62 interference
63 ‘ ‘
’ ’
64 ‘ ‘
’ ’
65 start of 14
66 end of 14
67 logic unit

1. A method for data transmission between an encoder and a motor and/or actuator control unit via an insecure multi-channel channel, comprising the multi-channel channel is formed as a black channel that forms a non-secure transmission channel that is verified by a higher-level or downstream instance an additional security protocol is superimposed on the black channel comprising the non-secure protocol thereof, and t the security protocol transmits additional data, preferably relating to the integrity and security of the data transmitted via the black channel, to two mutually independent evaluation units which generate a verifiable redundancy that is evaluated in a downstream functional module.

2. The method according to claim 1, wherein the black channel extends continuously from the position transformation to a secure evaluation unit, and interference of a general type can also be detected inside the encoder and inside the motor controller-side logic unit.

3. The method according to claim 1, wherein a secure evaluation unit is arranged at an output of the insecure channel, the secure evaluation unit configured to verify the data of the insecure channel and actuates the downstream motor and/or actuator unit only when the security of the verified data has been confirmed.

4. The method according to claim 1, wherein the data transmission via the insecure channel is at least two-channel.

5. The method according to claim 3, wherein the secure evaluation unit also has at least two channels, and a cross-comparison module is arranged between the two evaluation units, which module verifies the signals of the two evaluation units at least for identity.

6. The method according to claim 5, wherein the signals of the two evaluation units are additionally verified at least for synchrony and convergence.

7. The method according to claim 5, wherein an “approval” occurs at the output of the secure evaluation unit and the downstream motor and/or actuator unit is actuated only in the event of all the signals of the two evaluation units and the cross-comparison unit connected therebetween corresponding to one another.

8. The method according to claim 5, wherein the secure evaluation unit carries out a series of control requests for the signals thereof that are transmitted on all channels, which control requests have to be fulfilled with specific results of a verification unit, and an output signal for the single- or multi-channel actuation of the motor and/or actuator unit is generated at an output of the secure evaluation unit only when all the control requests present have been cumulatively fulfilled.

9. A device for data transmission between an encoder and a motor and/or actuator control unit via an insecure multi-channel channel, an insecure channel connected to the output of an encoder-side interface or directly to the rotary encoder, which channel is formed as a two- or four-wire line and is connected to the input of a secure evaluation unit, the output of which is connected to the motor-side motor control unit.

10. The device according to claim 9, wherein the transmitted data are verified for integrity and security only at an end of a transmission path, and a secure evaluation unit is arranged at an output of the insecure channel, which secure evaluation unit is at least two-channel.

11. The device according to claim 10, wherein a cross-comparison of the channels is in addition also carried out in the region of the two-channel evaluation unit.

12. The device according to claim 9, the two-channel design relates to a number of mutually independently determined positions.

13. The device according to claim, wherein the secure evaluation unit is arranged between in the motor control unit.

14. The device according to claim 9 wherein the input of the insecure channel is directly connected to the output of the rotary encoder.

15. The device according to claim 14, wherein the insecure channel also extends through the motor-side control unit.
